(19) United States
(12) Patent Application Publication
(10) Pub. No.: US 2019/0095663 A1
(43) Pub. Date: Mar. 28, 2019

(54) Method and System for Monitoring Food Products

(71) Applicant: Michael W. Ayette, Brookville, OH (US)

(72) Inventor: Michael W. Ayette, Brookville, OH (US)

(73) Assignee: Dayton-Phoenix Group, Inc., Dayton, OH (US)

(21) Appl. No.: 16/138,296

(22) Filed: Sep. 21, 2018

Related U.S. Application Data
(60) Provisional application No. 62/561,919, filed on Sep. 22, 2017.

(51) Int. Cl. G06K 7/10; G06K 7/14

(52) U.S. Cl. CPC G06K 7/10366; G06K 7/1413

(57) ABSTRACT

A system for monitoring items, in particular food products, includes a food storage cabinet having an interior with a plurality of food storage compartments; a plurality of food storage containers shaped to fit within the compartments, each of the containers having machine-readable indicia associated therewith indicative of an aspect of the food product therein; a plurality of sensors, each sensor associated with a different one of the food storage compartments to read the machine-readable indicia of the food storage container in the associated food storage compartment; and a display that receives and displays data from the first plurality of sensors indicative of the aspects of the food products in the food storage containers.

### TECHNICAL FIELD

This disclosure relates to systems and methods for tracking items, and in particular to methods and systems for monitoring the condition of food products in food preparation, storage, and service facilities.

### BACKGROUND

In food preparation facilities, food storage facilities, and food service facilities, it is important to monitor the status of prepared food products throughout the lifecycle of the food products. An important metric of this status is the freshness of the food product, which can be determined as a function of the residence time of the food product in the serving container in which it is packed at the food preparation facility. Freshness may vary depending upon the type of food product or products in the container, and whether they are cooked or raw. Once a food product has passed its predetermined acceptable residence time in its food container, it is no longer fresh and either becomes unappealing in taste, texture, or appearance, or worse, spoils and is unfit to be consumed.

Frequently, a food product is prepared at a food preparation facility, placed in a serving container, and the container is sealed. The sealed container later may be stored in a refrigerated state at the preparation facility. The sealed container then may be shipped to a food service facility, which may be a grocery store or a restaurant, such as a fast food or fast casual restaurant. At the food service facility, the sealed container may be purchased by a consumer, or opened and incorporated into a self-service buffet or a food preparation counter.

To prevent inadvertently using food product that may have spoiled or otherwise become unusable, at some point in their lifecycle such containers may be labeled with a sticker that includes a visually perceptible “USE BY” date. However, there is no system for automatically monitoring each food container during its entire lifecycle and generating an alert in the event that the food product in the container is or is approaching the end of its useful life.

### SUMMARY

The present disclosure describes a method and system for monitoring items such as food products that reduces the likelihood of inadvertently providing food product that has exceeded its residence time in a storage container. In embodiments, the disclosed system monitors the freshness of containerized food products throughout the lifecycle of the food product. The system provides a continuous monitoring of the freshness in real time, and in embodiments, provides freshness information locally at the site of the food product container and at a central location.

The disclosed method and system is scalable, relatively inexpensive to implement, and has wide application. The disclosed method and system is adaptable to track shelf life of any item or container of items.

In an embodiment, the disclosed system for monitoring food products includes a first food storage cabinet having an interior with a plurality of food storage compartments; a plurality of food storage containers shaped to fit within the compartments, each of the food storage containers having machine-readable indicia associated therewith indicative of an aspect of the food product therein, the aspect selected from one or more of a type of the food product, a weight of the food product, a location of packing the food product in the food storage container, a date of packing the food product in the food storage container, and an expiration date of the food product in the food storage container; a first plurality of sensors, each sensor of the first plurality of sensors associated with a different one of the food storage compartments to read the machine-readable indicia of one of the plurality of food storage containers in the associated one of the food storage compartments; and a display that receives and displays data from the first plurality of sensors indicative of the aspects of the food products.

In another embodiment, a system for monitoring items includes a receptacle having an interior with a plurality of compartments; a plurality of containers shaped to fit within the compartments, each of the containers having machine-readable indicia associated therewith indicative of an aspect of the item therein, the aspect selected from one or more of a type of the product, a weight of the item, a location of packing the item in the container, a date of packing the item in the container, and an expiration date of the item; a plurality of sensors, each sensor of the plurality of sensors associated with a different one of the compartments to read the machine-readable indicia of one of the plurality of containers in the associated one of the compartments; and a display that receives and displays data from the plurality of sensors indicative of the aspects of the items.

In yet another embodiment, a food processing facility includes a food preparation line that prepares food items and loads the food items into a plurality of food storage containers; a labeler that affixes machine-readable indicia to each of the plurality of food storage compartments, the machine-readable indicia containing information of the food items in the associated one of the food storage containers; a food storage cabinet having a plurality of food storage compartments that receive the food storage containers from the labeler; a plurality of sensors, each of the plurality of sensors associated with a different one of the food storage compartments to read from one of the machine-readable indicia of one of the plurality of food storage containers an associated one of the food storage compartments; and a display that displays an aspect of the food items in the food storage containers in the food storage compartments.

Other objects and advantages of the disclosed method and system for monitoring food products will be apparent from the following description, the accompanying drawings, and the appended claims.

### BRIEF DESCRIPTION OF THE DRAWINGS

FIG. 1 is a schematic front elevation of a component of an embodiment of the disclosed method and system for monitoring food products; and

FIG. 2 is a schematic front elevation of another component of the embodiment of the disclosed method and system for monitoring food products, the first and second components connected at A-A.

### DETAILED DESCRIPTION

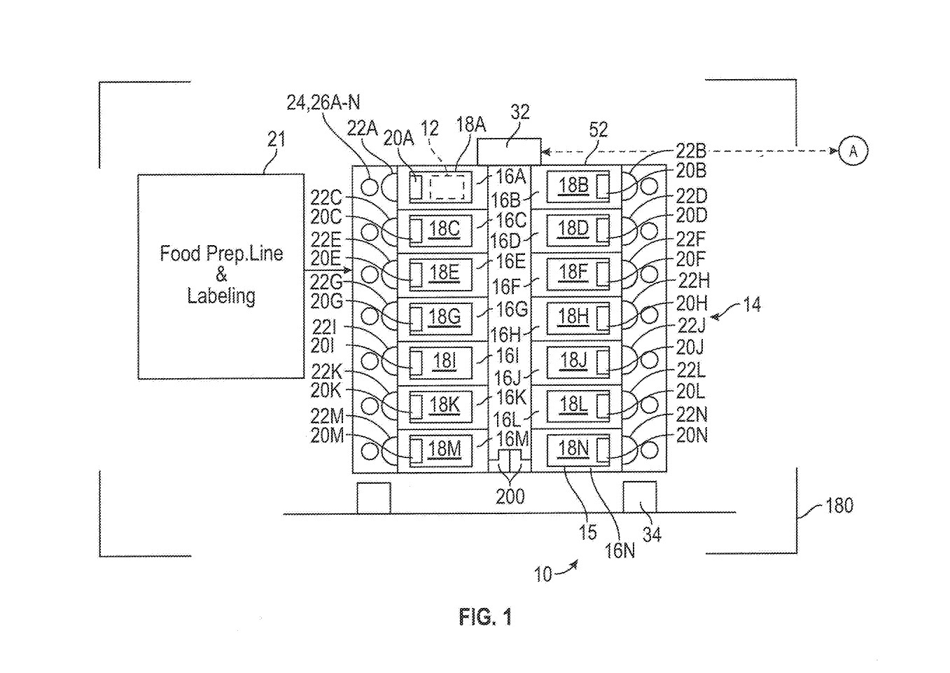

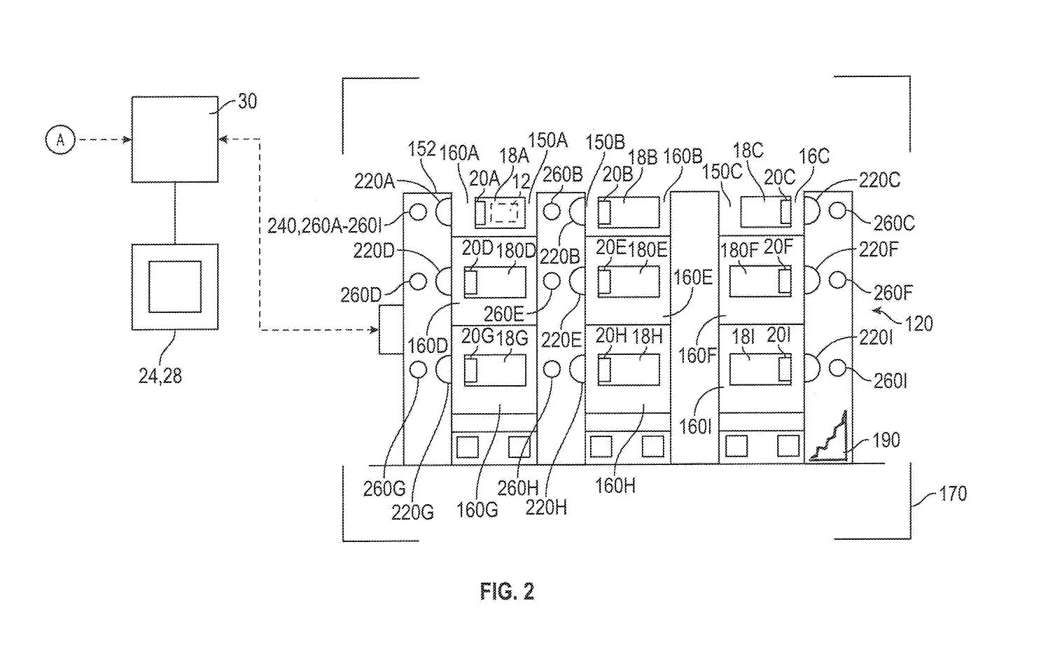

FIGS. 1 and 2 show, in an exemplary embodiment, a system, generally designated 10, for monitoring items such as food products 12. Although the disclosed system 10 and method of its operation may be adapted readily to accommodate any item, which may include parts or components, both solid and liquid (e.g., paint or other liquid coating or constituent), for assembly into or application to a larger device or composition, or any non-edible or non-consumable item, the disclosed system and method will be described herein as applied to tracking comestibles such as food products. As used herein, the term “food products” encompasses not only all manner of animal protein, fruits, and vegetables, both raw and prepared or cooked, chilled, frozen, heated, or at room temperature, but medicine, vitamins, supplements in either liquid or solid form, and any other item that can be consumed by, inhaled by, or topically applied by a human or an animal, such as a dog or cat.

The system 10 includes a first food storage cabinet 14 having an interior 15 that, in exemplary embodiments, is divided into plurality of food storage compartments 16A, 16B, 16C, 16D, 16E, 16F, 16G, 16H, 16I, 16J, 16K, 16L, 16M, and 16N, which may be arranged in parallel vertical stacks. The first food storage cabinet 14 includes front doors 200 that provide front access to the first plurality of food storage compartments 16A-16N. A plurality of food storage containers 18A, 18B, 18C, 18D, 18E, 18F, 18G, 18H, 18I, 18J, 18K, 18L, 18M, and 18N are contained within the storage compartments 16A-16N in one-to-one correspondence.

Each of the food storage containers 18A-18N carries machine-readable indicia 20A, 20B, 20C, 20D, 20E, 20F, 20G, 20H, 20I, 20J, 20K, 20L, 20M, and 20N containing information indicative of an aspect of the food product 12 in the food storage container with which it is associated. In embodiments, the indicia 20A-20N may be in the form of labels applied by a labeling machine of a food preparation line 21. The information contained in the machine-readable indicia 20A-20N in embodiments is selected from one or more of the types of food products in each of the associated food storage containers 18A-18N, the weights of the food products in each of the associated food storage containers, the packing plant(s) and/or packing line(s) that packed the food products 12 in the associated food storage containers, the dates of packing the food products in each of the food storage containers, and/or the expiration dates of the food products in each of the food packing containers. The cabinet 14 includes a first plurality of sensors 22A, 22B, 22C, 22D, 22E, 22F, 22G, 22H, 22I, 22J, 22K, 22L, 22M, and 22N.

In an embodiment, each of the machine-readable indicia 20A-20N includes a bar code, and each of the plurality of sensors 22A-22N includes a bar code scanner. Each of the plurality of sensors 22A-22N is associated with a different, corresponding one of the food storage compartments 16A-16N in one-to-one correspondence (e.g., 22A with 16A, 22B with 16B, etc.) and is configured to read the information from the adjacent or associated one of the machine-readable indicia 20A-20N of the plurality of food storage containers 18A-18N in the associated food storage compartment 16A-16N. In another exemplary embodiment, the machine-readable indicia 20A-20N may take the form of individual radio frequency identification (RFID) tags, and are paired in one-to-one correspondence with the sensors 22A-22N in the form of RFID readers. Together, the tags 20A-20N and readers 22A-22N form an RFID system that may be selected from a passive reader active tag (PRAT) system, an active reader passive tag (ARPT) system, and/or an active reader active tag (ARAT) system.

In an exemplary embodiment, the system 10 includes a display 24 that generates an indication of the of the food product 12 in one or more of, and in embodiments each one of the food storage containers 18A-18N in the food storage compartments 16A-16N. The display 24 may take the form of a plurality of indicators mounted on the first food storage cabinet, such as visually perceptible lights 26A, 26B, 26C, 26D, 26E, 26F, 26G, 26H, 26I, 26J, 26K, 26L, 26M, and 26N associated in one-to-one correspondence with each of the food storage compartments 16A-16N. The lights 26A-26N may be activated by the display 24 to project different colors corresponding to a state of the food product 12 in the associated containers 18A-18N.

Alternatively, or in addition, the system 10 includes a visual display screen, such as a video screen 28. In embodiments, video screen 28 is part of a central computer control 30, which in other embodiments takes the form of a microcontroller or a programmable logic controller, that communicates wirelessly and/or by a hardwire connection with a local control 32, which may be mounted on or integral with the cabinet 14. The local control 32 is connected to the sensors 22A-22N and transmits the information read by the sensors from the indicia 20A-20N to the central control 30. The central control 30 may be physically local to the cabinet 14, or may be at a remote facility.

Alternatively, each of the sensors 22A-22N is connected directly to a corresponding one of the indicator lights 26A-26N in one-to-one correspondence, so that each of the indicator lights receives a signal directly from its associated sensor. In that embodiment, each of the sensors 22A-22N includes or is operatively connected to a processor (e.g., operatively connected to processor 32) that interprets the information contained in the associated scanned indicia 20A-20N and displays a first selected value, which may be a numerical display, or selected color on one of the associated indicator lights 26A-26N.

For example, if the information on the indicia 20 of a given food container 18 indicates that the food product 12 is fresh, which may mean that the food product is fewer than a first predetermined number of days and/or hours old (e.g., measured from when the food product was packed into its food container 18 at food preparation line 21), or that the current date (e.g., year, month, and day) is not later than a date, such as an expiration date, encoded in the indicia 20, the sensor processor reads the packing date or expiration date from the associated indicia 20 and actuates the associated light 26 to show a first color, such as green.

When the date from the indicia 20 indicates that the age of the food product 12 (i.e., measured days and/or hours from packing in the container 18 or proximity to the encoded expiration date) is beyond the first predetermined number of days and/or hours old, or within a proximity range to the expiration date, but less than a second predetermined number of days and/or hours old or closer to the expiration date than the proximity range, the sensor processor 22 actuates its associated light 26 to display a second value or color, such as yellow.

When the date from the indicia 20 indicates a number of days and/or hours greater than the second predetermined number, or between the proximity range and the expiration date, the sensor processor 22 actuates its associated light 26 to display a third value or color, such as red. That third value or color may indicate that the food product 12 content of the associated food container 18A-18N should be discarded and not used. In this exemplary embodiment, the first and second predetermined number of days and/or hours may be varied from one of the plurality of sensors 22A-22N to another, which may depend upon the type or types of food product 12 sealed within the food containers 18A-18N. The values for the first and second predetermined number of days and/or hours may be stored on the indicia 20A-20N for each of the food containers 18A-18N.

In an exemplary embodiment, the first food storage cabinet 14 is insulated and includes a first temperature control unit that cools and/or heats the interior 15 containing the plurality of food storage compartments 16A-16N. The temperature control unit may be integrated into the central control 32 and include a sensor or probe within the interior of the first food storage cabinet 14, so that the first temperature control unit heats and/or cools the interior of the food storage cabinet 14 so that the food products 12 contained in the plurality of food storage containers 18A-18N in the plurality of food storage compartments 16A-16N is maintained at a preselected temperature, or within a preselected temperature range, or at or below a preselected temperature.

The first food storage cabinet 14 may take the form of a portable cabinet that optionally includes wheels 34 for moving the first food storage cabinet, and a stationary food storage cabinet, either embodiment of which may be configured for domestic or commercial use. In an exemplary embodiment, the first food storage cabinet 14 may be configured for domestic use, in which case the interior 15 may be divided into compartments 16A-16N, or instead may be undivided, in which case the compartments take the form of food storage shelves.

The food storage containers 18A-18N may take the form of one or more of plastic wrapping of individual food products 12, paperboard and/or plastic boxes of food products, glass and/or plastic jars of food products, cartons and/or bottles of liquid food products, and/or glass or plastic containers of food products in the form of medicines, vitamins, and the like, including any item that may be consumed by or taken orally by a human. In each case, the food storage containers 18A-18N would include indicia 20A-20N that have data identifying the particular food or medicinal item it contains, and an expiration date for that particular food or medicinal item.

With such a system, a single sensor 22 may be employed, in which case the local control 32 would be programmed to actuate the sensor to read and/or interrogate each food storage container 18A-18N and display locally on a display 24 the expired item by type and date, and/or by a photograph or other identifying image. In other embodiments, the first storage cabinet 12 may be used in a hospital or other medical facility to store food products 12 in the form of perishable drugs stored in storage containers 18A-18N in the form of packages with indicia 20A-20N in the form of bar codes or RFID tags indicating expiration dates and/or other information. In still other embodiments, the first storage cabinet may or may not be heated and/or cooled, and store such perishable items as glues, pastes, paint, varnish, greases, plastics, chemicals, and combinations of the foregoing. In each case the perishable item may be tagged, or enclosed within a container tagged with an indicia, such as a bar code or RFID tag, that contains information that includes an expiration date.

In other embodiments, the system 10 includes a second food storage cabinet 120. The second food storage cabinet 120 optionally may have a second plurality of food storage compartments 160A-160I arranged in a plurality of vertical columns. The second food storage cabinet may have openings 150A-150C on an upper surface 152 thereof shaped to provide access food 12 contained in the food storage containers 18A-18C contained in uppermost ones 160A-160C of the food storage compartments 160A-160I. The second food storage cabinet 120 optionally includes a second plurality of sensors 220A-220I. Each of the second plurality of sensors 220A-220I is associated with a different one of the second plurality of food storage compartments 160A-160I and is configured to read the information from one of the machine-readable indicia 20A-20I of one of the plurality of food storage containers 18A-18I in the associated food storage compartment.

A second display 240 generates a condition of the content 12 of the food storage containers 18A-18I in the second plurality of food storage compartments 160A-160I. The second display 240 may take the form of a plurality of visual indicator lights 260A-260I that are connected to and actuated by the second plurality of sensors 220A-220I. In an exemplary embodiment, the second plurality of indicator lights 260A-260I may operate in the same manner as the indicator lights 26A-26N of the first cabinet 12 described above. Alternatively, or in addition, the control 30 is connected, either wirelessly or by hardwire, to receive from the second sensors 220A-220I information read from the indicia 20A-20I on the plurality of food containers 18A-18I.

The second food storage cabinet 120 may include a second refrigeration unit that provides a cooled interior containing the second plurality of food storage compartments 160A-160I, whereby food 12 contained in the plurality of food storage containers 18A-18I in the second plurality of food storage compartments 160A-160I is maintained at or below a preselected temperature.

In an exemplary embodiment, the second food storage cabinet 120 does not have its own food storage compartments or indicator lights. Rather, the interior of the cabinet 120 is shaped to receive one or more first food storage cabinets 12. In such an embodiment, the first food storage cabinet 12 may include a top panel 52 that provides access to uppermost ones of the first plurality of food storage compartments 16A, 16B. The top panel 52 optionally may include access openings selected from removable plates, sliding doors, and hinged doors to provide access to the topmost food storage compartments 16A, 16B.

With either embodiment, the second food storage cabinet 120 includes front doors 190 that provide front access to one or the other of the first plurality of food storage compartments 16A-16N and the second plurality of food storage compartments 160A-160I. This access facilitates reloading and/or replacement of the food storage containers 18A-18N into the food storage compartments 16A-16N, 160A-160I.

In an exemplary embodiment of the system 10, the second food storage container 120 is located at a food service facility, which may be a grocery store or a restaurant, such as a fast food or fast casual restaurant. Additionally, the first food storage container 12 is located at a food processing facility 180 that may include the food preparation line and labeling machine 21.

While the forms of methods and systems herein described constitute preferred embodiments of the disclosed method and system for monitoring food products, it is to be understood that the invention is not limited to these precise forms of methods and systems, and that changes may be made therein without departing from the scope of the invention.

What is claimed is:

1. A system for monitoring food products, the system comprising:
a first food storage cabinet having an interior with a plurality of food storage compartments;
a plurality of food storage containers shaped to fit within the compartments, each of the food storage containers having machine-readable indicia associated therewith indicative of an aspect of the food product therein, the aspect selected from one or more of a type of the food product, a weight of the food product, a location of packing the food product in the food storage container, a date of packing the food product in the food storage container, and an expiration date of the food product in the food storage container;
a first plurality of sensors, each sensor of the first plurality of sensors associated with a different one of the food storage compartments to read the machine-readable indicia of one of the plurality of food storage containers in the associated one of the food storage compartments; and
a display that receives and displays data from the first plurality of sensors indicative of the aspects of the food products.

2. The system of claim 1, wherein the first food storage cabinet is insulated and includes a first temperature control unit that cools and/or heats the interior containing the plurality of food storage compartments, and includes a temperature sensor whereby food contained in the plurality of food storage containers in the plurality of food storage compartments is maintained within at a preselected temperature, or within a preselected temperature range, or at or below a preselected temperature.

3. The system of claim 2, wherein the first food storage cabinet is selected from a portable cabinet that optionally includes wheels for moving the first food storage cabinet, and a stationary food storage cabinet for domestic or commercial use.

4. The system of claim 1, wherein the display optionally includes a plurality of indicators, each of the plurality of indicators associated with a different one of each of the food storage compartments, wherein the plurality of indicators generates an indication of the condition of the content of the food storage container in the food storage compartments.

5. The system of claim 4, wherein the plurality of indicators is mounted on the first food storage cabinet.

6. The system of claim 5, wherein the plurality of indicators includes visually perceptible lights associated with each of the food storage compartments; and wherein a color of the lights indicates the condition of the content of the food storage containers.

7. The system of claim 1, further comprising a control connected to receive the information read from the machine-readable indicia by the plurality of sensors.

8. The system of claim 7, wherein the display is a video screen; and the control displays the information on the video screen.

9. The system of claim 1, wherein the machine-readable indicia is selected from a bar code and a radio frequency identification (RFID) tag; and the plurality of sensors is selected from bar code scanners and RFID readers, respectively, and combinations thereof.

10. The system of claim 1, further comprising a second food storage cabinet; the second food storage cabinet optionally having a second plurality of food storage compartments arranged in a plurality of vertical columns, and having openings on an upper surface thereof shaped to provide access food contained in the food storage containers contained in uppermost ones of the food storage compartments.

11. The system of claim 10, wherein the second food storage cabinet optionally includes a second plurality of sensors, each of the second plurality of sensors associated with a different one of the second plurality of food storage compartments and configured to read the information from one of the machine-readable indicia of one of the plurality of food storage containers in the associated food storage compartment; and
a second display that generates a condition of the content of the food storage containers in the second plurality of food storage compartments.

12. The system of claim 11, wherein the second food storage cabinet includes a second refrigeration unit that provides a cooled interior containing the second plurality of food storage compartments, whereby food contained in the plurality of food storage containers in the second plurality of food storage compartments is maintained at or below a preselected temperature.

13. The system of claim 11, wherein the second food storage cabinet is shaped to receive the first food storage cabinet.

14. The system of claim 13, wherein the first food storage cabinet includes a top panel that includes access openings selected from removable plates, sliding doors, and hinged doors that provide access to uppermost ones of the first plurality of food storage compartments.

15. The system of claim 11, wherein the second food storage cabinet includes front doors that provide access to one or the other of the first plurality of food storage compartments and the second plurality of food storage compartments.

16. The system of claim 11, wherein the control is connected to receive from the second sensors information read from the indicia on the plurality of food containers.

17. The system of claim 11, wherein the second food storage container is located at a food service facility.

18. The system of claim 17, wherein the first food storage cabinet is shaped to receive food storage containers from a food preparation line at a food processing facility.

19. A system for monitoring items, the system comprising:
a receptacle having an interior with a plurality of compartments;
a plurality of containers shaped to fit within the compartments, each of the containers having machine-readable indicia associated therewith indicative of an aspect of the item therein, the aspect selected from one or more of a type of the product, a weight of the item, a location of packing the item in the container, a date of packing the item in the container, and an expiration date of the item;
a plurality of sensors, each sensor of the plurality of sensors associated with a different one of the compartments to read the machine-readable indicia of one of the plurality of containers in the associated one of the compartments; and
a display that receives and displays data from the plurality of sensors indicative of the aspects of the items.

20. A food processing facility, the facility comprising:
a food preparation line that prepares food items and loads the food items into a plurality of food storage containers;
a labeler that affixes machine-readable indicia to each of the plurality of food storage compartments, the machine-readable indicia containing information of the food items in the associated one of the food storage containers;
a food storage cabinet having a plurality of food storage compartments that receive the food storage containers from the labeler;
a plurality of sensors, each of the plurality of sensors associated with a different one of the food storage compartments to read from one of the machine-readable indicia of one of the plurality of food storage containers an associated one of the food storage compartments; and
a display that displays an aspect of the food items in the food storage containers in the food storage compartments.
